(19) United States
(12) Patent Application Publication
(10) Pub. No.: US 2022/0318280 A1
(43) Pub. Date: Oct. 6, 2022

(54) Map-Based Information Engine

(71) Applicant: Hector Clark, Brooklyn, NY (US)

(72) Inventor: Hector Clark, Brooklyn, NY (US)

(21) Appl. No.: 17/658,106

(22) Filed: Apr. 6, 2022

Related U.S. Application Data
(60) Provisional application No. 63/200,975, filed on Apr. 6, 2021.

(51) Int. Cl. G06F 16/29; G06F 16/2457; G06F 16/242

(52) U.S. Cl. CPC G06F 16/29; G06F 16/24575; G06F 16/2428

(57) ABSTRACT

A map-based information engine is implemented in which a map-based information service retrieves and stores data associated with a plurality of geographic locations. Exemplary forms of data can include news, weather, demographics, sports scores, lottery numbers, transportation statuses, travel information (e.g., distance, flight costs, hotels), etc. The map-based information engine may associate such stored information with one or more relevant locations, including a town, county, bureau, state, zip code, country, etc. An end user can access the location-based information using a locally instantiated maps application or web browser. The maps application's user interface may display a map of the entire globe or a section of the globe. Clicking on a given location causes the maps application to pull and present information pertaining to that given location, such as the news or travel information, and also causes the map to zoom in on that location.

### CROSS-REFERENCES TO RELATED APPLICATIONS

This Non-Provisional Utility patent application claims the benefit of and priority to U.S. Provisional Patent Application Ser. No. 63/200,975, filed Apr. 6, 2021, entitled “Map-Based Information Engine,” the entire contents of which is hereby incorporated herein by reference.

Despite advances in the Internet and the use of social media, news and information can be bottlenecked or stunted from reaching parts of the globe. For example, a user in the United States may not be aware of a tsunami in Japan until the following day when their news feed releases an article. Translation issues and a local news agency's ability to retrieve and relay the information, among other barriers, can cause delays for certain parts of the world from learning information, whether that information is vital, entertaining, or otherwise. Regardless of translation issues, the ability to learn information about a distant location can be difficult for a remote resident.

### SUMMARY

A map-based information engine is implemented in which a map-based information service retrieves and stores data associated with a plurality of geographic locations. Exemplary forms of data can include news, weather, demographics, sports scores, lottery numbers, transportation statuses, forecasts, local stores, banks, and restaurants, travel information (e.g., distance, flight possibilities and costs, local hotels, etc.), among other information associated with a geographical parameter. The map-based information engine may associate such stored information with one or more relevant locations, including a town, county, bureau, state, zip code, country, etc.

Once the database has been established with location-based information, an end user can access such information using a locally instantiated maps application or web browser (hereinafter individually and collectively referred to as a “maps application”). The maps application's user interface may display a map of the entire globe or a section of the globe. The globe is separated into parts, such as states, countries, continents, etc., that the user can click. Clicking on a given location causes the maps application to pull and display information pertaining to that given location, such as news, weather, travel information, etc. The map may also zoom in on that location and then further divide the location into further parts; for example, a state may be divided into towns, zip codes, etc. Further break-down patterns may also be possible, such as continents breaking down by country.

Selected geographical location information may be displayed in a series of widgets below the displayed map. The widgets may be re-configurable according to the user's preferences. Furthermore, certain widgets remote to the selected geographic location may display preferred or exceptional content, such as viral content that has received a certain number of ‘likes,’ views,’ and the like. A threshold number or percentage associated with the content may be set before reaching the viral or exceptional content widget (e.g., 100 k likes, 70% of viewers, etc.).

In addition to retrieving and presenting geographically relevant data, the maps application is further configured to enable user action at the presented data. For example, sporting information directed to scores or local teams can interoperate with a ticket office to enable users to purchase tickets to the sporting event or place a bet for that specific game or match. Clicking on the country of Japan can enable the user to assess airplane travel times and prices, hotel prices and locations, and make a purchase. A translation Application Programming Interface (API) may interoperate with the maps application to enable the user to assess local events in Japan as well, such as where the popular nightlife is, and children-friendly events are, among other information. Such information can be presented contemporaneously while enabling the user to book a trip through the maps application. This way, the user can learn the intricacies of a location while deciding where to book their hotel stay.

The maps application is also configured with animated lines between two locations. For example, the animated lines can be used to show a connection between the user's location and their selected geographic location. Alternatively, the animated line may show the user's location relative to a remote user who is virtually speaking through the maps application. Thus, the maps application is configured to provide a video and/or audio call feature which displays the users on the map and an animated line to show their distance. The animated line can be acted on via a user input, which can show the distance between the users, travel information such as an airplane or car distance and travel time, and local hotel information, availability, and pricing.

The map-based information engine provides a unique user experience when learning about a remote geographic location. Such a user experience hastens the time for the news to travel around the globe by circumventing language barriers using a translation API and enabling a remote user to quickly find information about a distant location. The interoperation among the APIs that provide such data to the maps application creates a dynamic environment of information that otherwise may be difficult for the user to obtain. Such configurations enhance a typical map's capabilities of delivering and presenting information to users while simultaneously streamlining the user's experience.

### BRIEF DESCRIPTION OF THE DRAWINGS

FIG. 1 shows an illustrative representation of a map-based information service retrieving various types of data;

FIG. 2 shows an illustrative schema of data that the service may retrieve;

FIG. 3 shows an illustrative representation of associating data with geographical locations;

FIG. 4 shows an illustrative representation of different geolocations for specific points of data;

FIG. 5 shows an illustrative representation of how data is evaluated for a geolocation

FIG. 6 shows an illustrative representation in which the user device accesses the map-based information service

FIG. 7 shows an illustrative representation of a user device displaying an interactive map;

FIG. 8 shows an illustrative representation of the United States responsive to a user's selection on the interactive map;

FIG. 9 shows an illustrative representation of information associated with the location selected by the user;

FIG. 10 shows an illustrative representation of the map indicating a geographic location responsive to a user's input;

FIG. 11 shows an illustrative representation of information associated with a relatively narrower geolocation;

FIG. 12 shows an illustrative representation of a dynamic line between two participants in a phone call using the maps application;

FIG. 13 shows an illustrative representation of travel information which is propagated responsive to two users being on a phone call;

FIG. 14 shows an illustrative representation of customizable widgets;

FIG. 15 shows a simplified block diagram of a computing device, such as a smartphone, laptop computer, or desktop computer, which may be used to implement the present map-based information engine; and

FIG. 16 shows a simplified block diagram of a computing device, such as a desktop computer or remote service, which may be used to implement the pre-set map-based information engine.

### DETAILED DESCRIPTION

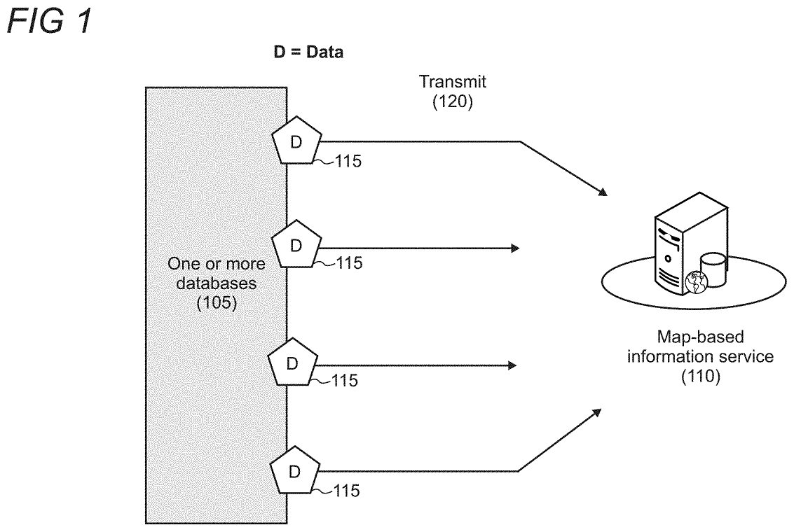

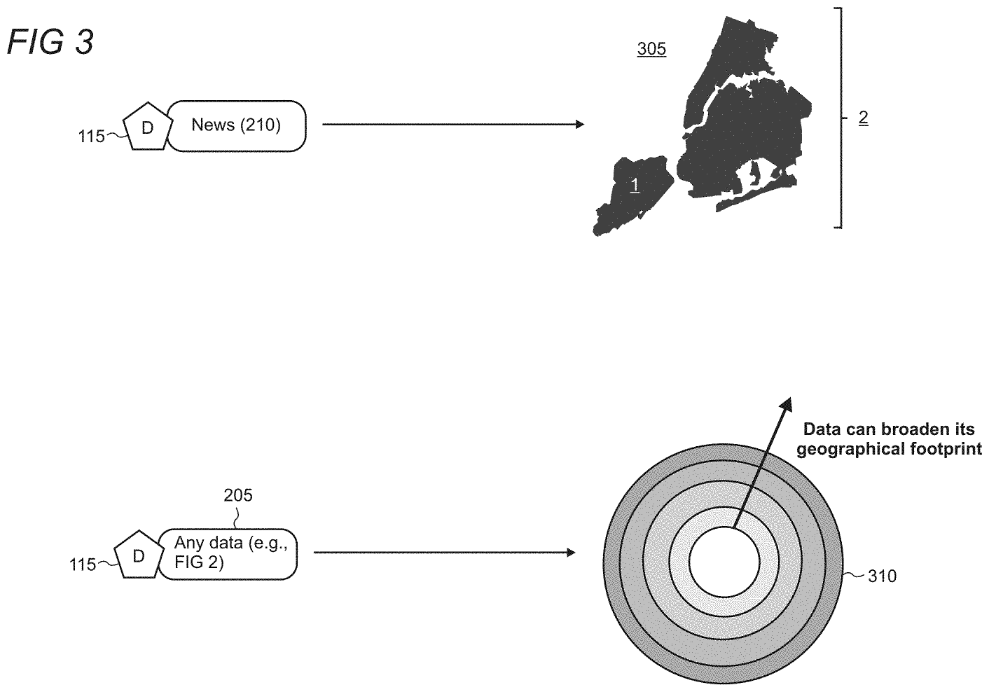

FIG. 1 shows an illustrative diagram in which data 115 derived from one or more databases 105 are transmitted 120 to a map-based information service 110. The data may be transmitted over some network (FIG. 3) and stored within a database associated with the service. This data is parsed and utilized by the map-based information service for access by users. The service stores and associates the information in a geolocation manner such that retrieved information is associated with a given area on a virtual map rendered on a user's device.

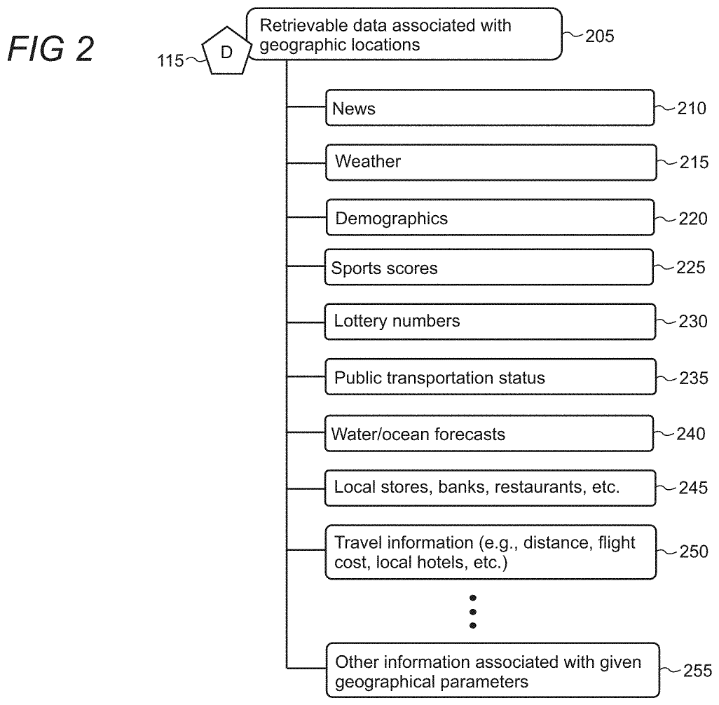

FIG. 2 shows an illustrative schema of retrievable data 115 associated with geographic locations 205. The non-exhaustive data includes news 210, weather 215, demographics 220, sports scores 225, lottery numbers 230, public transportation status 230, water/ocean forecasts 240, local stores, banks, restaurants, etc. 245, travel information (e.g., distance to a location, flight cost, local hotels, etc.) 250, and other information associated with given geographical parameters 255.

Each piece of data may be associated with a given location on a virtual map rendered on a computing device's display. For example, a user can access and view that day's lottery numbers for Georgia's state lottery by clicking anywhere within Georgia's state lines on a rendered virtual map. Furthermore, if a user clicks on a more specific location, such as the city of Atlanta, the user may receive news specifically for that location. News in other parts of Georgia may be excluded or arranged further down the list. Thus, the map associates relevant information to specific points on the virtual map, which is retrieved responsive to user selection.

FIG. 3 shows an illustrative representation in which the remote service associates the data 115 to specific geolocations 305. For example, news data 210 may be associated with a particular borough, Staten Island (1), or can be associated with a greater geographic area, such as all of New York City (2). This data may start out specific to a given town, zip code, borough, etc., and can expand to a greater geographic area. Alternatively, if the news is originally relevant to all of a State or New York City, then it may be associated with that entire geographic location from the start.

The exemplary geographic area 310 shows how data can broaden its geographical footprint over time. For example, a piece of retrievable data 205 may start out in a specific zip code, town, or state and can gradually increase its geographical footprint based on surrounding circumstances, such as its popularity, number of views, number of likes, the nature of the article affecting greater geographical areas, among other factors.

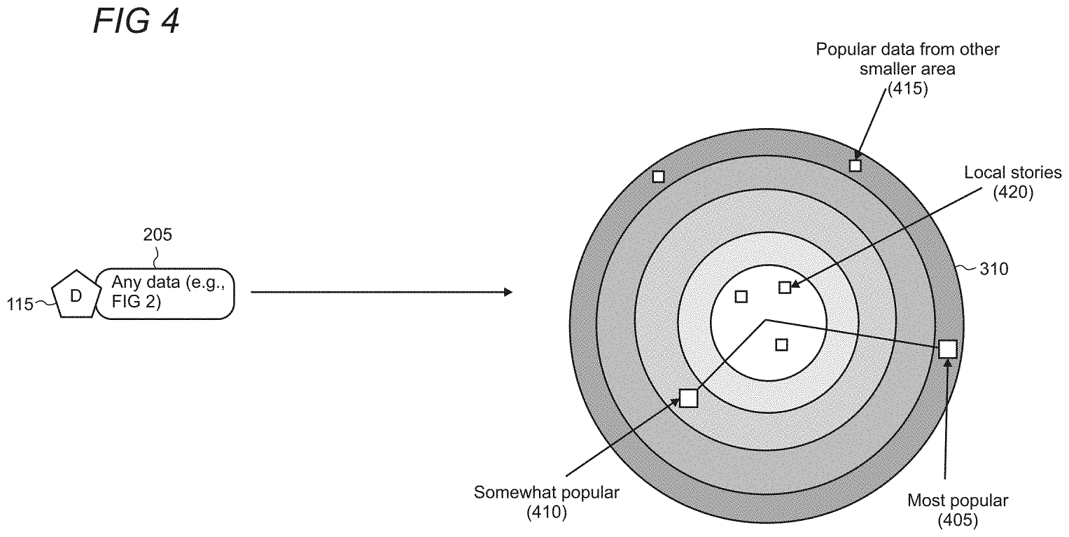

FIG. 4 shows an illustrative representation in which specific instances of retrievable data 205 can propagate outward to cover a greater geographical footprint. For example, local stories 420 may be specific to a given zip code, for example, that is not particularly relevant or well-liked/viewed outside of that local. In contrast, the most popular 705 items of data that originated in a given zip code or town may expand to a greater geographical area (e.g., multiple zip codes, state-wide, countries, continents, etc.). Between those two are various other geographical areas for somewhat popular 710 data. Popular data from other smaller areas 415 can also be observed on this geographical area 310 since users on this map can also see stories from other towns.

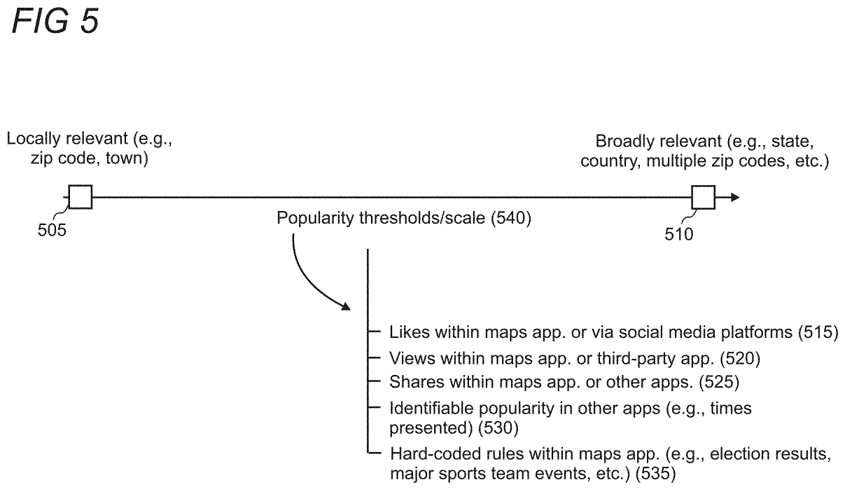

FIG. 5 shows an illustrative representation in which a sliding scale or popularity threshold 540 for individual pieces of retrievable data 205 is associated with geographical areas. Locally relevant (e.g., zip code, town) retrievable data may be associated with point 505 on the scale, and broadly relevant (e.g., state, country, multiple zip codes, etc.) can be associated with point 510—retrievable data can likewise fall in between. Thus, retrievable data, such as news stories, may be associated with a geolocation based on its topic, location, and overall popularity or lack thereof. Data is not necessarily affixed to one specific point at content generation and identification but rather can increase or decrease its geographical footprint over time based on identifiable factors.

Non-exhaustive factors can include ‘likes’ within a maps application or via social media platforms 515, views within the maps application or third-party application 520, shares within the maps application or other applications 525, identifiable popularity in other applications (e.g., times presented) 530, and hard-coded rules within the maps application (e.g., election results, major sports team events, etc.). Such hard-coded rules can be relevant on a national basis, such as a sports team's cheating scandal or a local team winning a national championship.

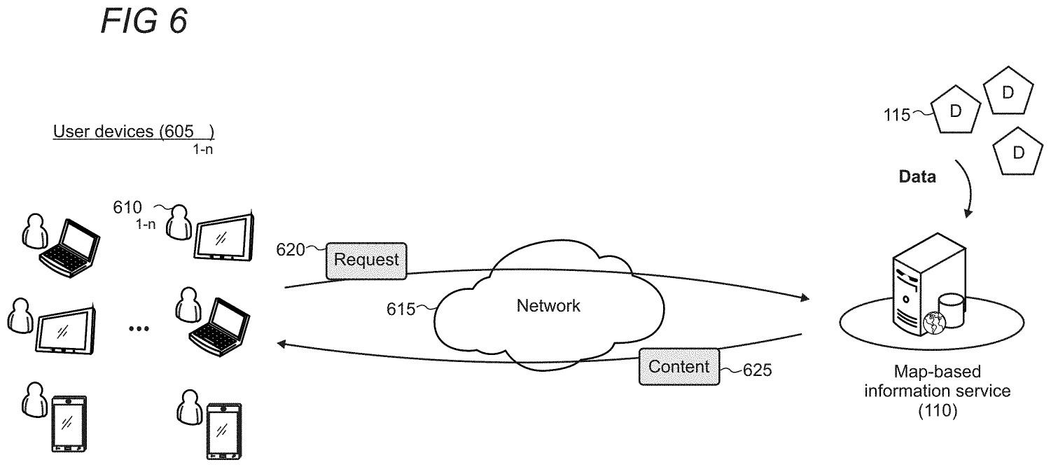

FIG. 6 shows an illustrative representation in which a user 3610, operating user device 605, accesses the map-based information service 110. The user's computing device may be configured with a network interface, such as a network interface card (NIC) which enables a wired or wireless connection to a network access point and thereby the network 615. The network can include any one or more of a local area network (LAN), wide area network (WAN), the Internet, or the World Wide Web.

User 610 may access the service's information using a locally-instantiated application or a web browser that accesses a uniform resource locator (URL). Responsive to the user accessing and requesting 620 data from the service 110, the map-based information service may transmit content 625 to the user's device 605. The content 625 may be an interactive virtual map that users can click and manipulate using a mouse pointer, touchscreen display, or other input mechanisms.

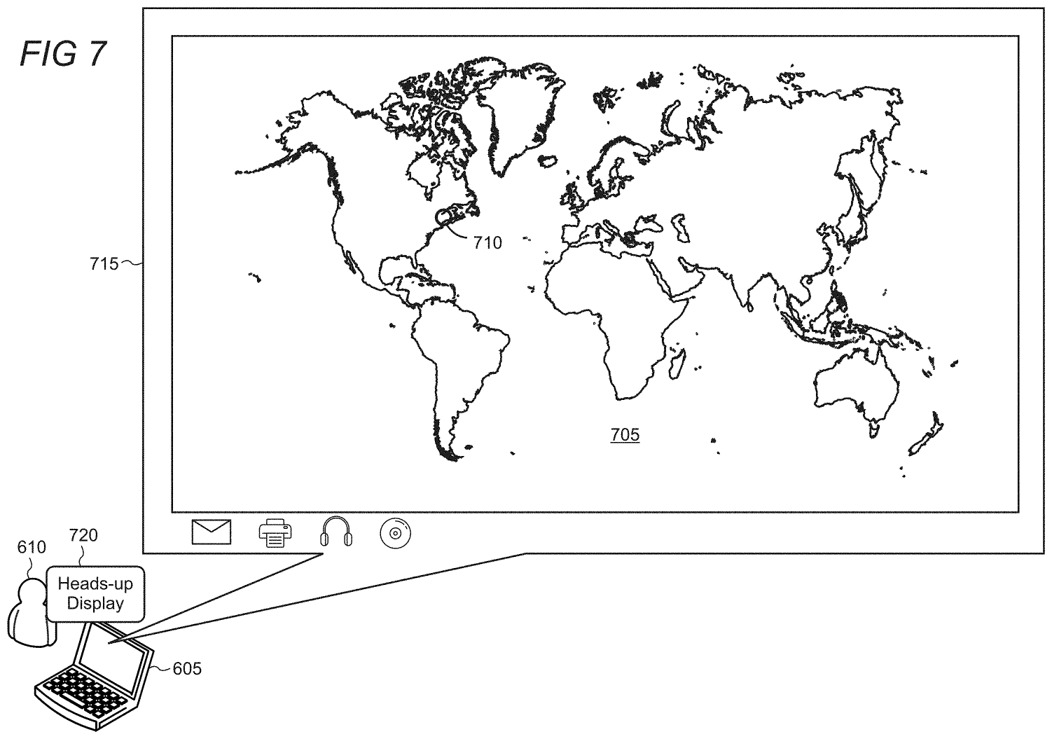

FIG. 7 shows an illustrative rendering of the world map 705 on the display 715 of the user's computing device 605. User 610 may select a location on the map, as representatively shown by input point 710. While a pointer or touchscreen display may be utilized as the input mechanism, a heads-up display (HUD) 620 system may also be implemented to work with the user's computing device and local application or browser implementation. Using the HUD system, the local application may receive an input or react responsively to the user's gaze direction and head position on the computing device's display 715. The HUD system may utilize an image-generating optical unit, a combiner that redirects a projected image, and a computer. In situations where the HUD system is utilized, some transparent display may be utilized instead of a typical display. However, even when a typical display screen on a computer is utilized, the application may operate with other system components that can identify a user's gaze as input.

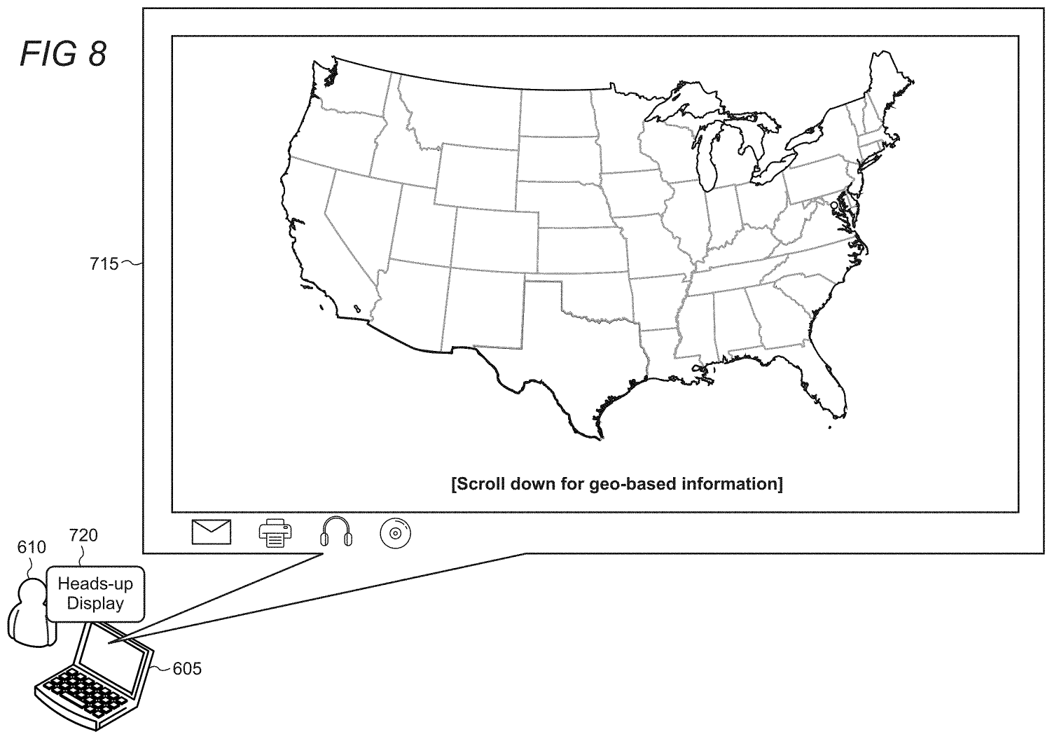

FIG. 8 shows an illustrative rendering of the United States map on user interface 715 responsive to the user, for example, selecting a location within the United States from the world map. Thus, for example, in some scenarios, the maps application may zoom in using some pre-defined set of rules responsive to a user selection. Thus, if a user selects the New York region as shown by input 710 in FIG. 7, the maps application may first show the entire United States before retrieving New York data. In other scenarios, however, the maps application may immediately show the New York region and retrieve the relevant geolocation information.

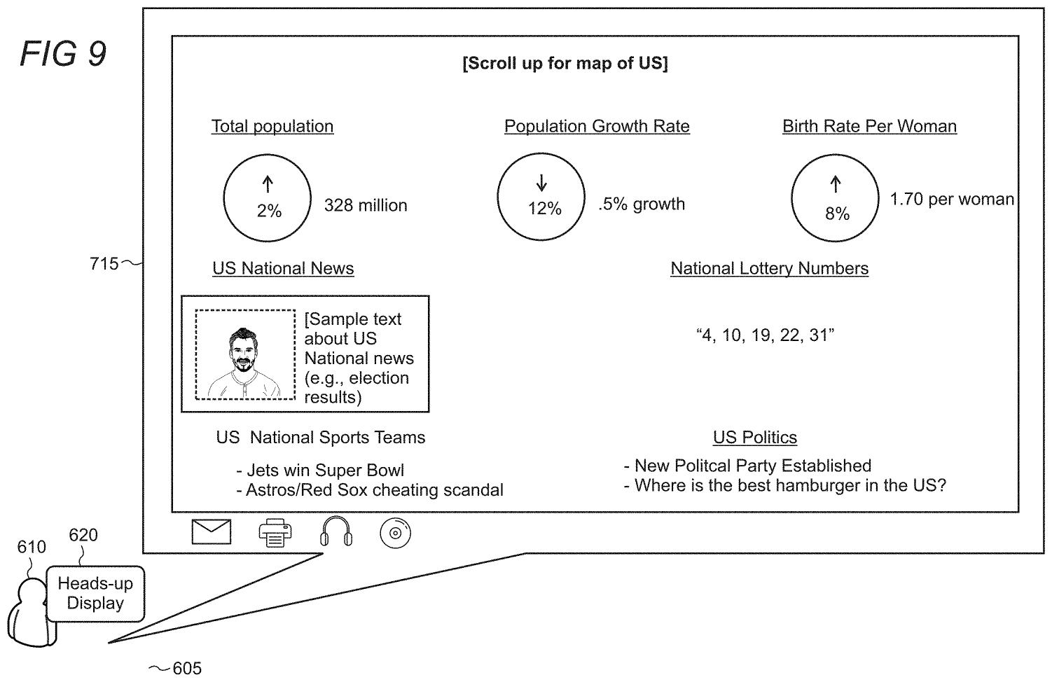

FIG. 9 shows an illustrative user interface on the device's display 715 in which information about the location selected by the user is propagated. This information may be required by the maps application and transmitted to the user's device from the map-based information service 110. Since the map zoomed in on the United States, national information is retrieved and presented to the user upon scrolling down. The information displayed can be, for example, the information shown in the schema in FIG. 2 and discussed above. The user interface shows the total population, population growth rate, birth rate per woman, national news, national lottery numbers, national sports coverage, and US national politics, among other information.

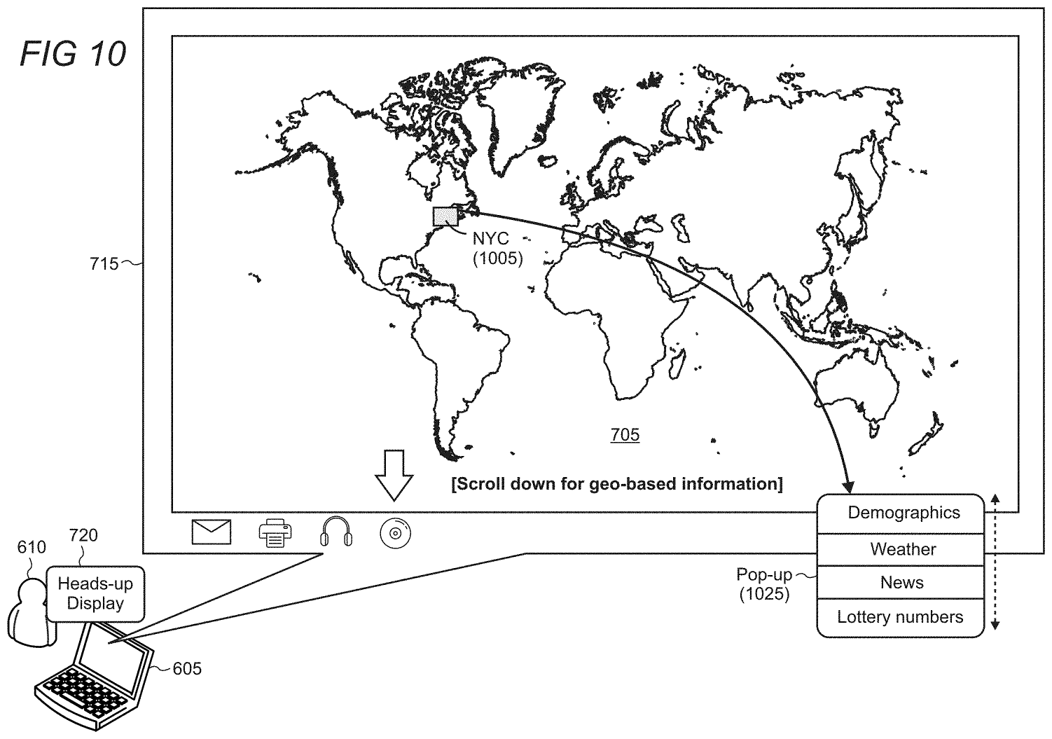

FIG. 10 shows an illustrative representation in which the location selected is on or about NYC (New York City) 1005. Upon selecting that location, the map-based information service 110 may transmit information about the selected geolocation to the user's computing device. Furthermore, a scrollable pop-up 1025 may be displayed, showing a series of commands or options that the user can request for that selected geolocation. The application may display information based on the user's selection of any one of those commands. While the information for NYC was immediately shown here, in other scenarios, the maps application may have first zoomed into the US, and then requested that the user re-select a location, at which point the scrollable pop-up 1025 would be presented.

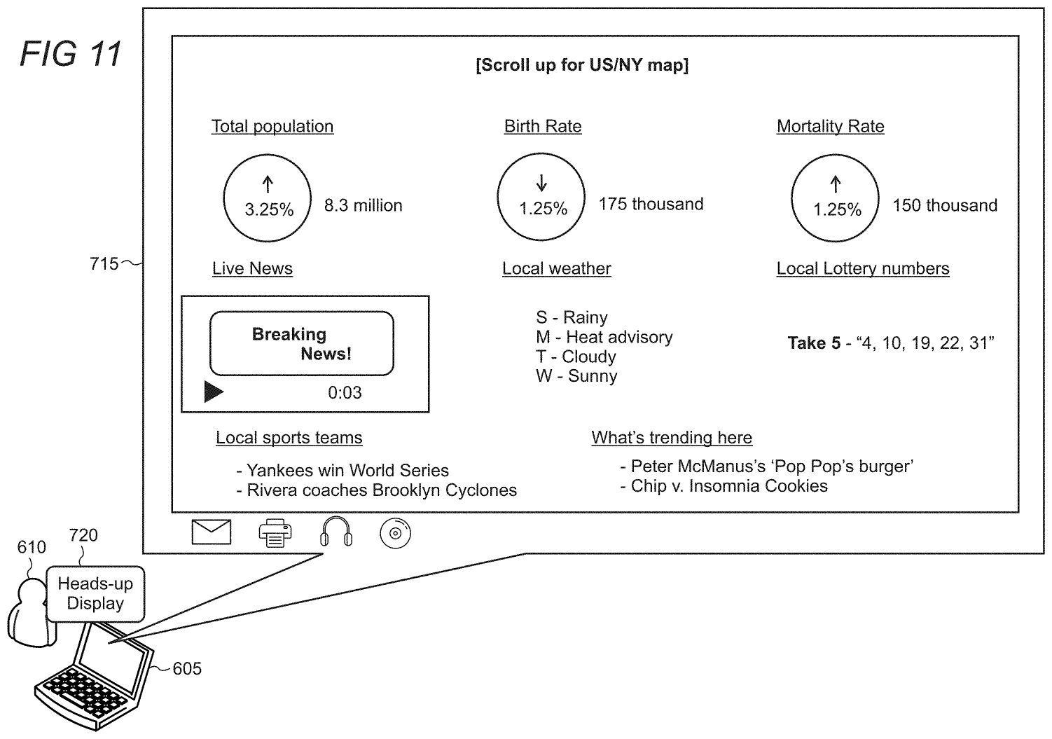

FIG. 11 shows an illustrative user interface on the device's display 715 in which information about the location (New York City) selected by the user is propagated. The information displayed can be, for example, the information shown in the schema in FIG. 2 and discussed above. The user interface shows the total population, birth rate, mortality rate, local news, local weather, local lottery numbers, local sports team information, and what's trending in that local area. As shown in FIG. 11, the local news feed may be a video clip from a local news channel—this would enable a local news reporter to receive national or international recognition for a given story. Social media and written articles for local areas can also receive wider recognition due to this platform. The shown user interface may be different than what would be displayed if the user selected one of the options or commands in the pop-up 1025 (FIG. 10). For example, selecting one of the pop-up menu options may cause the application to display only that information or highlight the requested information on the user interface shown in FIG. 11.

Showing local information responsive to a user selection can quickly and immediately display local information about the area. People can check out what is happening in an area before, for example, traveling for work or vacationing. Using a locally-instantiated translation tool can enable users to view foreign news without waiting for their local news agency to receive and relay such information. Furthermore, the maps application may pull additional surrounding data and grow the geolocation zone of information if, for example, the selected location does not have enough data to fill the information screen (FIG. 11). Thus, a certain amount of information may be pulled, which may also dictate how far the geolocation information is selected; that way, the user isn't presented with limited information.

Other information can also be derived by selecting a location on the map. For example, selecting Toronto, Canada can pull up the user's distance to that location, amount of time to arrive there, available modes of transportation, etc. The application may interoperate with traveling agency services to, for example, automatically display flight ticket prices, hotels, rental cars, and other traveling information.

The locally-instantiated application or browser accessing the map-based information service 110 may be configured with additional functionality. For example, a user's “home” page may be configured with various widgets, including selected stock symbols, a message box to chat with friends, and voice or video chat functionality, among other features. These additional features provide a greater ecosystem of features that revolve around the map-based information features. For example, users can send a news article they found in a town in Japan to their friend in Manhattan, N.Y.

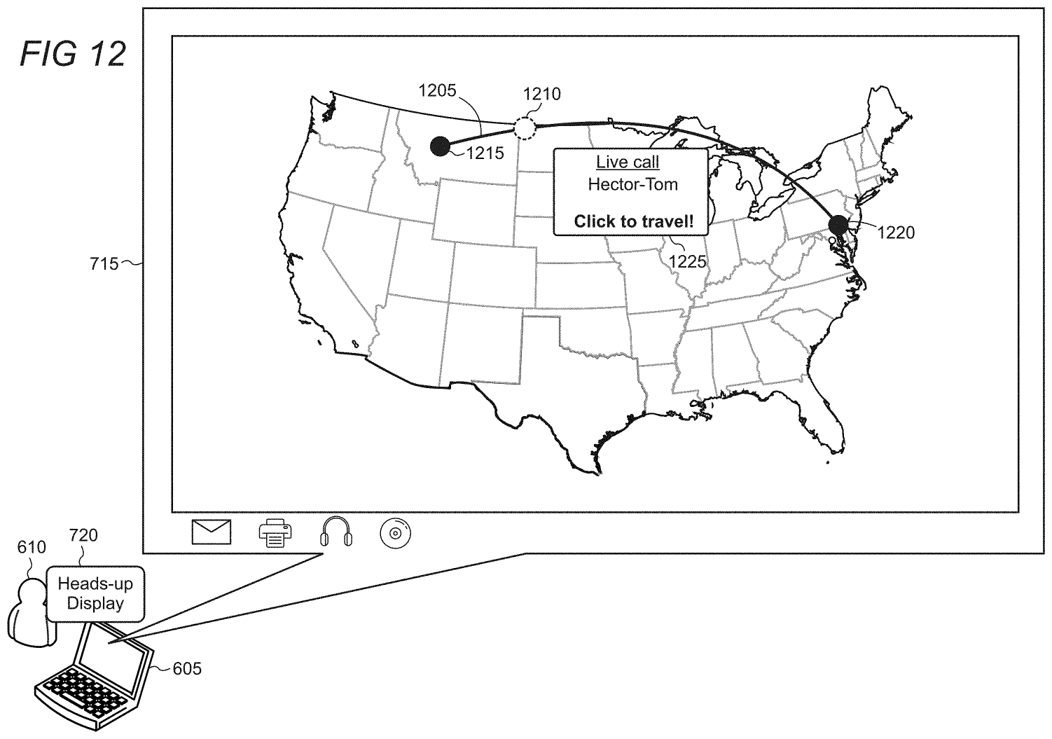

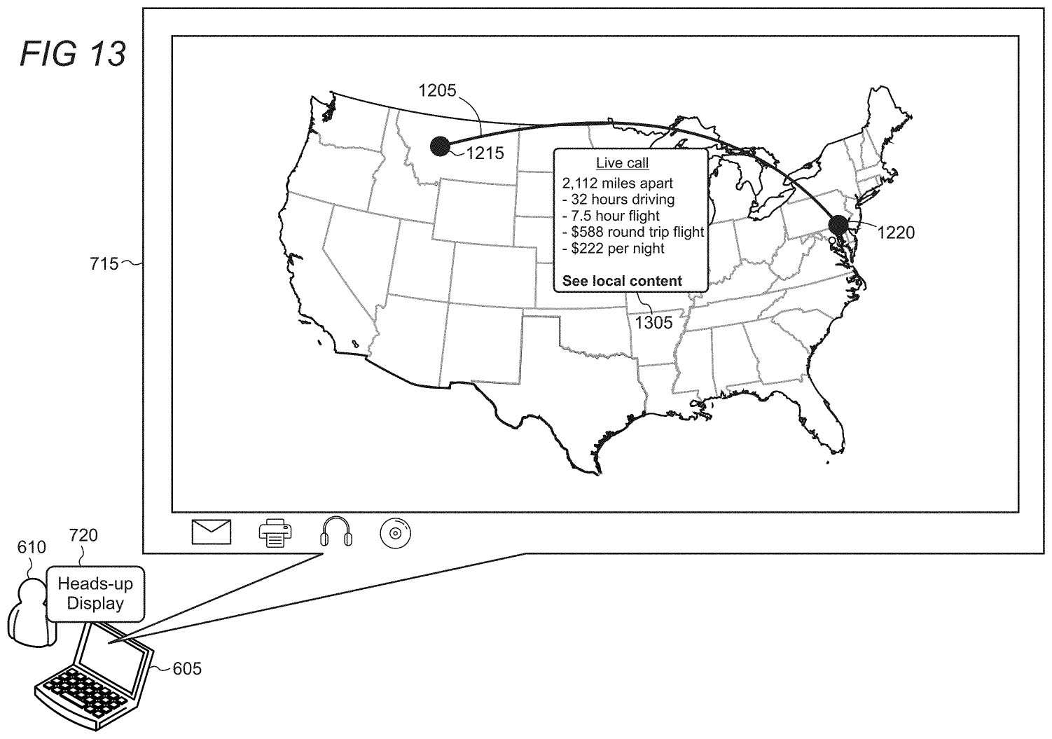

FIG. 12 shows an illustrative representation in which an animated connecting line 1205 is established between two participants 1215, 1220 during a virtual conversation. The virtual chat may be established using the maps application or a third-party API that interoperates with the maps application. The maps application pulls the respective user's locations, such as through their IP (Internet Protocol) addresses, and shows the animated connection line to illustrate the distance between the users. The connection line is animated by, for example, changing color, size, etc., during the live call. Responsively to the user clicking on the line, as shown by input 1210, information about traveling between those locations is retrieved and presented. For example, as shown in FIG. 13, the “Live call” box now shows the distance in miles between the users, the amount of time to drive or fly to each other, the cost of a round-trip air flight, and the cost of a round-trip air flight a hotel nigh. The users also can click on “See local content” to be presented with local information about that location (FIG. 11). Such information is either retrieved when the audio and/or video call is initiated or responsive to the user clicking on the animated connection line or the ‘Live call” box 1225 (FIG. 12).

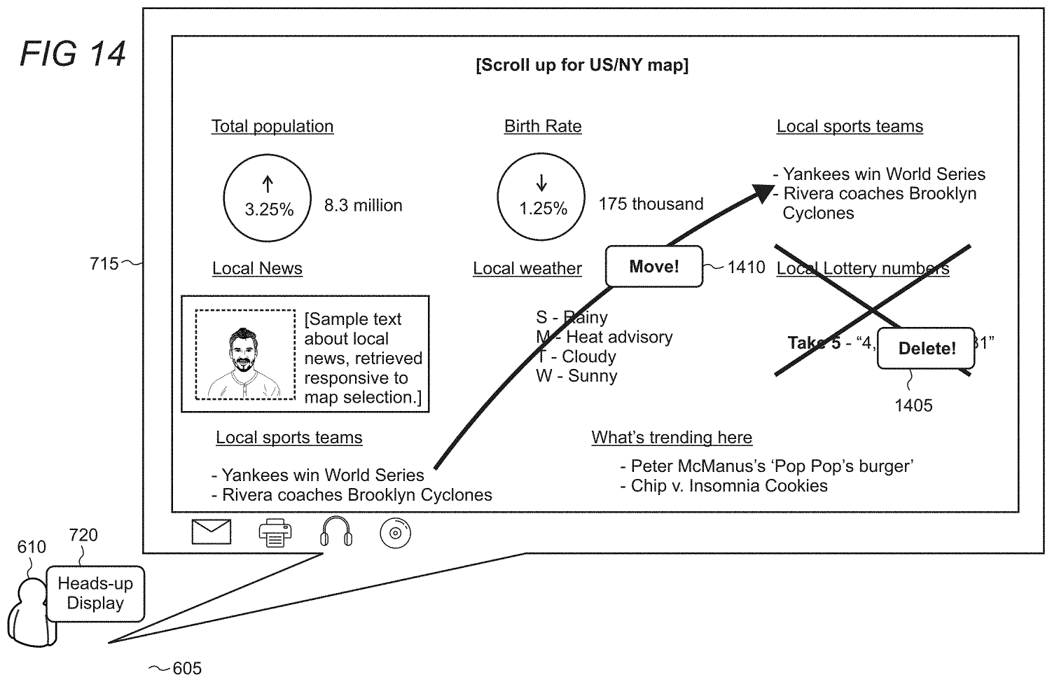

FIG. 14 shows an illustrative representation in which the various information widgets can be re-arranged by a user. For example, a user can click on a given widget, such as the “Local Lottery numbers,” and be presented with a Delete 1405 option by which that widget is deleted from the information screen. Furthermore, a user can select and drag a widget from one location to another, as representatively shown by numeral 1410. The user may move the widget by selecting and dragging the widget to another location. This may cause widgets to switch locations or may duplicate the moved widget to enable the user to delete any duplicates.

Furthermore, widgets may be utilized to relay information outside the selected geographical region in certain scenarios. For example, if a specific item of data is becoming so identifiably popular or viewed, an ‘exception widget’ may be utilized, which shows the user the viral content even though it's outside of their selected region. This way, the user can still stay informed about important events even if it is outside of their selected zone. Such a widget may appear similar to any of the categories shown in FIG. 11 or 14, only their content will describe the viral content. Its name may be, for example, ‘exception widget’ or ‘viral widget.”

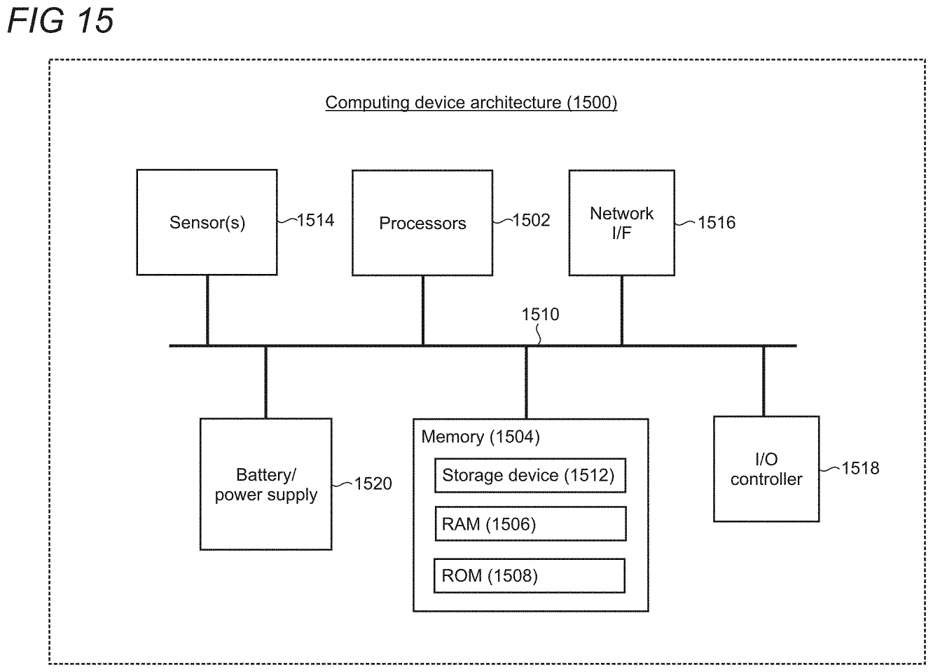

FIG. 15 shows an illustrative architecture 1500 for a device, such as a smartphone, tablet, laptop computer, or access device, capable of executing the various features described herein. The architecture 1500 illustrated in FIG. 15 includes one or more processors 1502 (e.g., central processing unit, dedicated AI chip, graphics processing unit, etc.), a system memory 1504, including RAM (random access memory) 1506, ROM (read-only memory) 1508, and long-term storage devices 1512. The system bus 1510 operatively and functionally couples the components in the architecture 1500. A basic input/output system containing the basic routines that help to transfer information between elements within the architecture 1500, such as during startup, is typically stored in the ROM 1508. The architecture 1500 further includes a long-term storage device 1512 for storing software code or other computer-executed code utilized to implement applications, the file system, and the operating system. The storage device 1512 is connected to processor 1502 through a storage controller (not shown) connected to bus 1510. The storage device 1512 and its associated computer-readable storage media provide non-volatile storage for the architecture 1500. Although the description of computer-readable storage media contained herein refers to a long-term storage device, such as a hard disk or CD-ROM drive, it may be appreciated by those skilled in the art that computer-readable storage media can be any available storage media that can be accessed by the architecture 1500, including solid-state drives and flash memory.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read-only memory), EEPROM (electrically erasable programmable read-only memory), Flash memory or other solid-state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 1500.

According to various embodiments, the architecture 1500 may operate in a networked environment using logical connections to remote computers through a network. The architecture 1500 may connect to the network through a network interface unit 1516 connected to the bus 1510. It may be appreciated that the network interface unit 1516 also may be utilized to connect to other types of networks and remote computer systems. The architecture 1500 also may include an input/output controller 1518 for receiving and processing input from a number of other devices, including a keyboard, mouse, touchpad, touchscreen, control devices such as buttons and switches, or electronic stylus (not shown in FIG. 15). Similarly, the input/output controller 1518 may provide output to a display screen, user interface, a printer, or other types of output device (also not shown in FIG. 15).

It may be appreciated that any software components described herein may, when loaded into the processor 1502 and executed, transform the processor 1502 and the overall architecture 1500 from a general-purpose computing system into a special-purpose computing system customized to facilitate the functionality presented herein. The processor 1502 may be constructed from any number of transistors or other discrete circuit elements, which may individually or collectively assume any number of states. More specifically, the processor 1502 may operate as a finite-state machine in response to executable instructions contained within the software modules disclosed herein. These computer-executable instructions may transform the processor 1502 by specifying how the processor 1502 transitions between states, thereby transforming the transistors or other discrete hardware elements constituting the processor 1502.

Encoding the software modules presented herein also may transform the physical structure of the computer-readable storage media presented herein. The specific transformation of physical structure may depend on various factors in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it may be appreciated that many types of physical transformations take place in the architecture 1500 in order to store and execute the software components presented herein. It also may be appreciated that the architecture 1500 may include other types of computing devices, including wearable devices, handheld computers, embedded computer systems, smartphones, PDAs, and other types of computing devices known to those skilled in the art. It is also contemplated that architecture 1500 may not include all of the components shown in FIG. 15, may include other components that are not explicitly shown in FIG. 15, or may utilize an architecture completely different from that shown in FIG. 15.

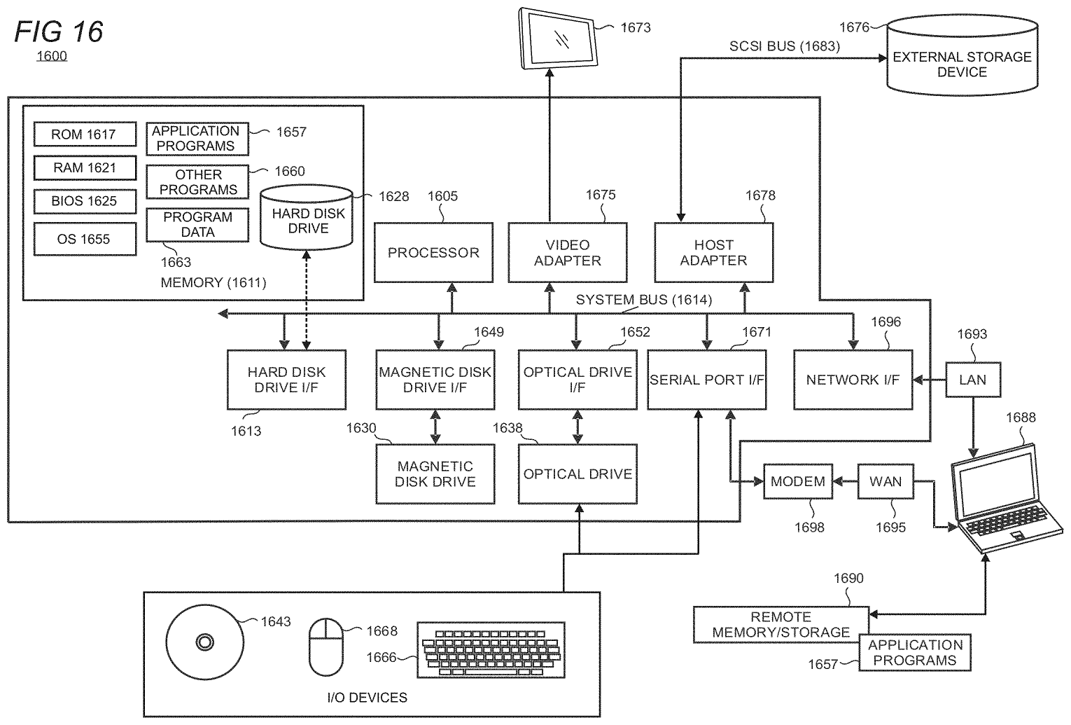

FIG. 16 is a simplified block diagram of an illustrative computer system 1600 such as a remote server, smartphone, tablet computer, laptop computer, or personal computer (PC) which the present disclosure may be implemented. Computer system 1600 includes a processor 1605, a system memory 1611, and a system bus 1614 that couples various system components including the system memory 1611 to the processor 1605. The system bus 1614 may be any of several types of bus structures, including a memory bus or memory controller, a peripheral bus, or a local bus using any of a variety of bus architectures. The system memory 1611 includes read-only memory (ROM) 1617 and random access memory (RAM) 1621. A basic input/output system (BIOS) 1625, containing the basic routines that help to transfer information between elements within the computer system 1600, such as during startup, is stored in ROM 1617. The computer system 1600 may further include a hard disk drive 1628 for reading from and writing to an internally disposed hard disk, a magnetic disk drive 1630 for reading from or writing to a removable magnetic disk (e.g., a floppy disk), and an optical disk drive 1638 for reading from or writing to a removable optical disk 1643 such as a CD (compact disc), DVD (digital versatile disc), or other optical media. The hard disk drive 1628, magnetic disk drive 1630, and optical disk drive 1638 are connected to the system bus 1614 by a hard disk drive interface 1646, a magnetic disk drive interface 1649, and an optical drive interface 1652, respectively. The drives and their associated computer-readable storage media provide non-volatile storage of computer-readable instructions, data structures, program modules, and other data for the computer system 1600. Although this illustrative example includes a hard disk, a removable magnetic disk 1633, and a removable optical disk 1643, other types of computer-readable storage media which can store data that is accessible by a computer such as magnetic cassettes, Flash memory cards, digital video disks, data cartridges, random access memories (RAMs), read-only memories (ROMs), and the like may also be used in some applications of the present disclosure. In addition, as used herein, the term computer-readable storage media includes one or more instances of a media type (e.g., one or more magnetic disks, one or more CDs, etc.). For purposes of this specification and the claims, the phrase “computer-readable storage media” and variations thereof, are intended to cover non-transitory embodiments and does not include waves, signals, and/or other transitory and/or intangible communication media.

A number of program modules may be stored on the hard disk, magnetic disk, optical disk 1643, ROM 1617, or RAM 1621, including an operating system 1655, one or more application programs 1657, other program modules 1660, and program data 1663. A user may enter commands and information into the computer system 1600 through input devices such as a keyboard 1666, pointing device (e.g., mouse) 1668, or touchscreen display 1673. Other input devices may include a microphone, joystick, game pad, satellite dish, scanner, trackball, touchpad, touch-sensitive device, voice-command module or device, user motion or user gesture capture device, or the like. These and other input devices are often connected to the processor 1605 through a serial port interface 1671 that is coupled to the system bus 1614, but may be connected by other interfaces, such as a parallel port, game port, or universal serial bus (USB). A monitor 1673 or other type of display device is also connected to the system bus 1614 via an interface, such as a video adapter 1675. In addition to the monitor 1673, personal computers typically include other peripheral output devices (not shown), such as speakers and printers. The illustrative example shown in FIG. 16 also includes a host adapter 1678, a Small Computer System Interface (SCSI) bus 1683, and an external storage device 1676 connected to the SCSI bus 1683.

The computer system 1600 is operable in a networked environment using logical connections to one or more remote computers, such as a remote computer 1688. The remote computer 1688 may be selected as another personal computer, a server, a router, a network PC, a peer device, or other common network node, and typically includes many or all of the elements described above relative to the computer system 1600, although only a single representative remote memory/storage device 1690 is shown in FIG. 16. The logical connections depicted in FIG. 16 include a local area network (LAN) 1693 and a wide area network (WAN) 1695. Such networking environments are often deployed, for example, in offices, enterprise-wide computer networks, intranets, and the Internet.

When used in a LAN networking environment, the computer system 1600 is connected to the local area network 1693 through a network interface or adapter 1696. When used in a WAN networking environment, the computer system 1600 typically includes a broadband modem 1698, network gateway, or other means for establishing communications over the wide area network 1695, such as the Internet. The broadband modem 1698, which may be internal or external, is connected to the system bus 1614 via a serial port interface 1671. In a networked environment, program modules related to the computer system 1600, or portions thereof, may be stored in the remote memory storage device 1690. It is noted that the network connections shown in FIG. 16 are illustrative, and other means of establishing a communications link between the computers may be used depending on the specific requirements of an application of the present disclosure.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computing device, comprising:
one or more processors;
one or more hardware-based memory devices storing computer-executable instructions which, when executed by the one or more processors, cause the computing device to:
render an interactive virtual map on a display associated with the computing device;
receive user input at a location on the virtual map;
responsive to receiving the user input, retrieve local information associated with the location, in which the retrieved local information is information that is within a defined geolocation on the virtual map; and
display the local information on the computing device's display.

2. The computing device of claim 1, wherein the defined geolocation is based on defined lines for a state, city, town, zip code, or neighborhood.

3. The computing device of claim 2, wherein the defined geolocation expands to enable propagation of a pre-set amount of information on the computing device's display.

4. The computing device of claim 1, wherein retrieved local information includes news, weather, demographics, sports scores, lottery numbers, public transportation status, water/ocean forecasts, local stores, banks, and restaurants, and travel information.

5. The computing device of claim 1, wherein, over time, the retrieved local information expands its geographical footprint.

6. The computing device of claim 5, wherein the retrieved local information expands its geographical footprint responsive to having an increased popularity or views.

7. The computing device of claim 1, wherein a menu pops up responsive to the user selecting the location, in which the pop-up provides various information categories for selection by the user.

8. The computing device of claim 1, wherein the retrieved local information is arranged in distinct widgets on the computing device's display, and the widgets are customizable.

9. A method to present information about a geolocation to a user, comprising:
receiving, at a map-based information service, data associated with geographic locations;
associating, at the map-based information service, the received data with geolocations, in which the geolocations associated with specific items of data are periodically updated;
receiving a request, at the map-based information service and from a user computing device, for content associated with a selected location;
transmitting, from the maps-based information service to the user computing device, portions of the received data based on the user's selected location.

10. The method of claim 9, further comprising expanding the geolocation associated with the specific items of data based on identifying an increased popularity associated therewith.

11. The method of claim 10, wherein the user computing device displays a world map within a maps application or browser and zooms in on a geographical area responsive to selection of the selected location, wherein the zoomed-in geographical area is broader than the selected location.

12. The method of claim 11, wherein the maps application or browser zooms in to the selected location using defined boundaries, including state lines, town lines, zip code lines, or county lines.

13. The method of claim 9, wherein the maps-based remote service transmits data outside of the selected location to the user computing device responsive to the data surpassing a threshold popularity level or view number.

14. One or more hardware-based non-transitory computer-readable memory devices storing computer-executable instructions which, when expected by one or more processors disposed in a computing device, causes the computing device to:
receive data associated with geographic locations;
associate the received data with geolocations, in which the geolocations associated with specific items of data are periodically updated;
receive, from a user device, a request for content associated with a selected location;
transmit, to the user device, portions of the received data based on the user's selected location.

15. The one or more hardware-based non-transitory memory devices of claim 14, wherein the executed instructions further cause the computing device to expand the geolocation associated with the specific items of data based on identifying an increased popularity associated therewith.

16. The one or more hardware-based non-transitory memory devices of claim 15, wherein the user device displays a world map within a maps application or browser and zooms in on a geographical area responsive to selection of the selected location, wherein the zoomed-in geographical area is broader than the selected location.

17. The one or more hardware-based non-transitory memory devices of claim 16, wherein the maps application or browser zooms in to the selected location using defined boundaries, including state lines, town lines, zip code lines, or county lines.

18. The one or more hardware-based non-transitory memory devices of claim 14, wherein the maps-based remote service transmits data outside of the selected location to the user computing device responsive to the data surpassing a threshold popularity level or view number.

19. The one or more hardware-based non-transitory memory devices of claim 14, wherein the associated geolocations with the retrieved information periodically expand or contract based on an associated metric for specific items of data.

20. The one or more hardware-based non-transitory memory devices of claim 14, wherein popularity of viewership is assessed based on third-party application data, including data from social media platforms.
